(19) United States
(12) Patent Application Publication
(10) Pub. No.: US 2006/0254059 A1
(43) Pub. Date: Nov. 16, 2006

(54) Knife apparatus

(76) Inventor: Christain Hampton, Salinas, CA (US)

Correspondence Address: LAW OFFICE OF MAI VU PARE, 9107 WILSHIRE BLVD. #450, BEVERLY HILLS, CA, 90210, US

(21) Appl. No.: 11/433,807

(22) Filed: May 12, 2006

Related U.S. Application Data
(60) Provisional application No. 60/680,356, filed on May 13, 2005.

(51) Int. Cl. B26B 1/00

(52) U.S. Cl. 30/138

(57) ABSTRACT

The present invention relates to a knife with a novel, improved handle and a sharpening element incorporated within the knife.

The present application claims priority from provisional application 60/680,356 filed May 13, 2005.

### BACKGROUND OF THE INVENTION

Knife sharpeners are old in the art and usually consist of a separate sharpening unit, constructed from steel or other resistant material. Such prior art devices may be in the form of a rod-like configuration. To sharpen, the cuffing portion of a knife is repeatedly scraped across the prior art sharpening unit until the cutting portion of a knife has been thinned out, so that it is sharpened.

A shortcoming of prior art knife sharpeners is that they must be stored and then located when needed, which may not always be convenient depending on how well organized the user's kitchen or work area is. In the restaurant or grocery business this may be especially irritating because cooking tools and accessories must often be quickly located and there are often numerous tools and accessories in a tight location.

In addition, prior art knife sharpeners are often awkward and difficult to use because the shape and design of many prior art devices are not ergonomic and require the user to assume awkward and uncomfortable positions.

The present invention addresses the above shortcomings by incorporating a knife sharpener within a knife. The present invention allows the user to easily store and locate the knife sharpener since it is located on the knife itself. In addition, the design of the knife sharpener is ergonomic and allows for safer sharpening of a knife because sharpening is accomplished with the blades of the knives being pointed away from the body.

### SUMMARY OF INVENTION

The present invention incorporates a knife-sharpening element contained within a knife. In a preferred embodiment of the invention, the knife-sharpening element of the knife is positioned opposite the cutting edge on the blade of the knife. The sharpening element is comprised of metal with rounded or non-perpendicular edges. To sharpen a knife, the blade of a separate knife is repeatedly run across the knife-sharpening element of the invention, and is sharpened by this action.

### DESCRIPTION OF DRAWINGS

FIG. 1 shows a perspective view of the knife sharpening invention.

FIG. 2 shows a cross sectional view of a preferred embodiment of the present invention.

FIG. 3 shows the knife sharpening invention in use with a second knife.

FIG. 4 shows an alternative embodiment of the invention.

### DETAILED DESCRIPTION OF THE INVENTION

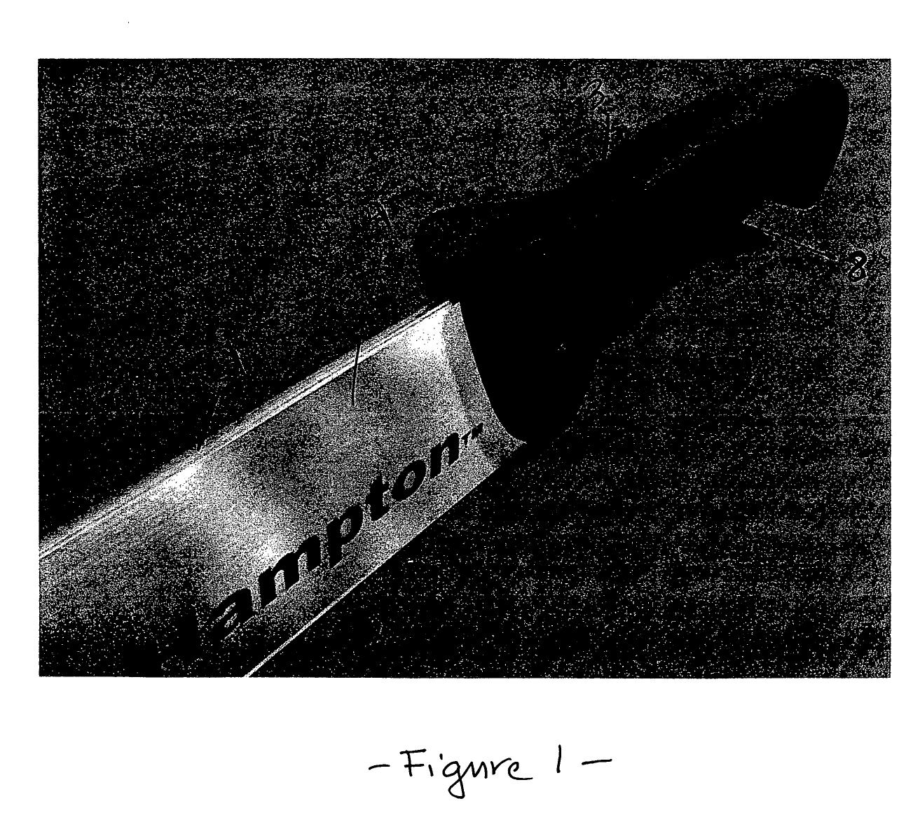

FIG. 1 shows a perspective view of the present invention. The present invention includes a sharpening element 1, a cutting element 2, and a handle 3. The sharpening element 1 and cutting element 3, each make up part of the blade 4 of the present invention.

The sharpening element 1 may be constructed from a variety of metals such as steel, aluminum alloys, or any other rigid, durable material. The material may also come from durable, synthetic materials, as advances in strength and durability in synthetic materials are continually being made. The sharpening element may be constructed from identical material as the cutting element of the blade, or from a different, more resistant material. If the cutting element and sharpening element are constructed from different materials, the elements may be joined through welding or other methods known in the art.

The handle 3 and blade 4 are joined through means known in the art including screws, fasteners, and welding. Die cast molds for handles may be configured to accommodate insertion of a blade during fabrication.

The handle may be constructed from a variety of materials including plastic, rubber, wood, or metal. A separate layer 8 of rubber or soft plastic may be provided to surround the handle portion to improve the users comfort and grip. The layer may be texturized with raised protuberances or comprise perforations for increased friction and grip. The handle may have a longitudinal length sufficient so that it extends past the user's hand when it is being held. The girth of the handle should be greater than half one inch for improved handling.

At the portion of the handle proximal to the blade, a concave ridge 7 may be provided. The concave ridge is large enough for a user to insert his thumb. The ridge may further comprise a rubber or soft plastic material to minimize slippage of the user's thumb when positioned within the ridge. When the user places his thumb in the ridge, the user is afforded greater comfort and stability when gripping the handle and sharpening a knife.

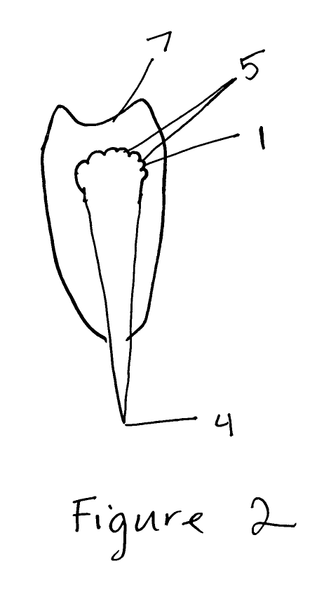

FIG. 2 shows a cross section of a preferred embodiment of the present invention. The sharpening element of the present invention may contain multiple, parallel grooves 5 which may extend the length of the sharpening element. The grooves 5 provide for enhanced sharpening of the blade by optimizing the angle at which the blade makes contact with the sharpening element.

The multiple grooves 5 also provide additional friction against the knife being sharpened when the user runs the knife against the sharpening element. The concave ridge 7 and parallel grooves provides an improved and novel means of sharpening a knife. Increased safety is provided by employing the present invention to sharpen a knife because the cutting element of the knives are pointed away from the user's body when being sharpened. It should be understood however, that the sharpening element comprising of grooves is not the only embodiment of the present invention. Various configurations of the sharpening element may exist and still fall under the scope of protection granted by this patent

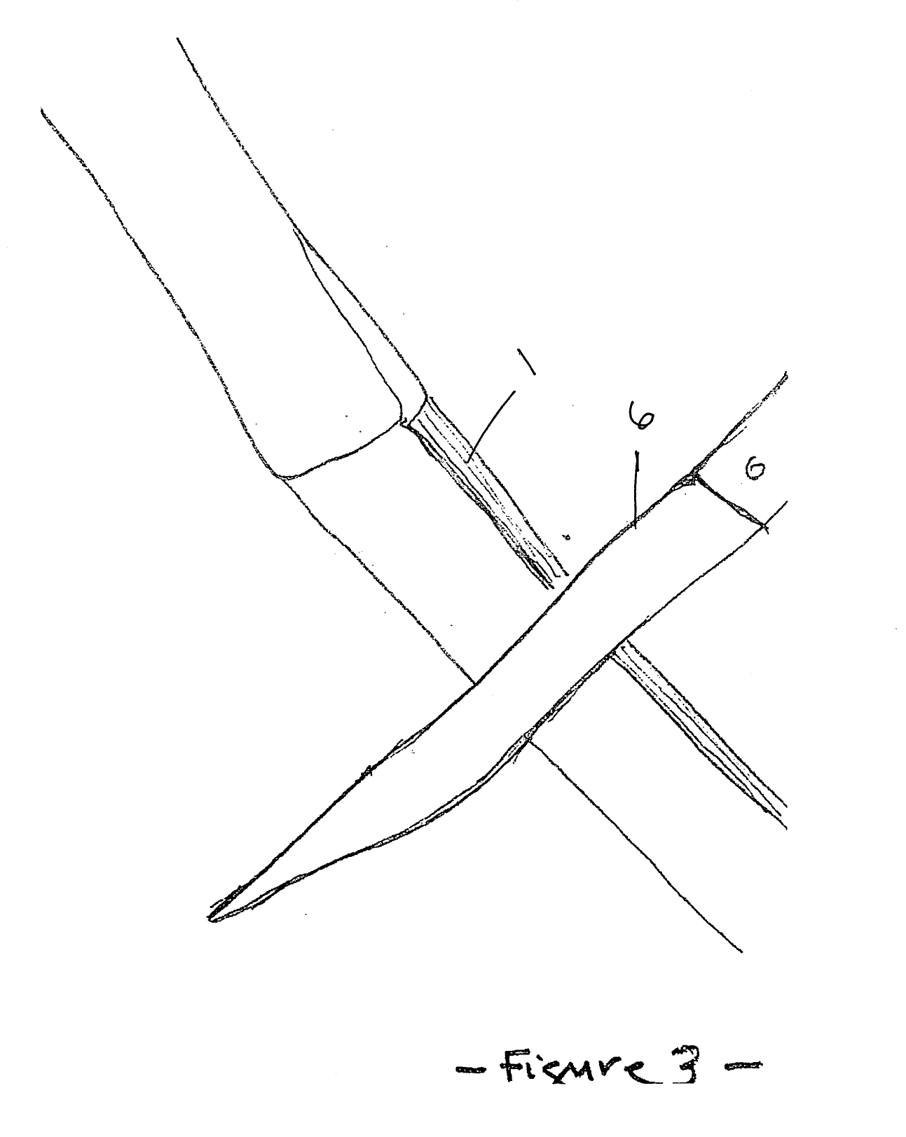

FIG. 3 shows the present invention in operation. The blade of a second knife 6 is run across the sharpening element 1 of the present invention in order to sharpen the second knife. The user controls the angle at which the second knife is sharpened. The user may place his thumb in the concave ridge 7 to improve comfort and control while sharpening the second knife.

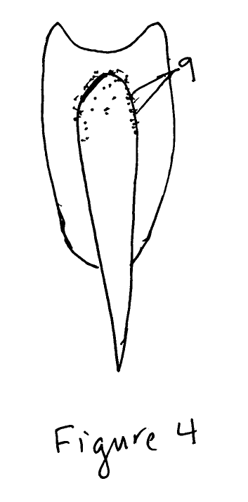

FIG. 4 shows an alternative embodiment of the present invention where diamond abrasives 9 enhance the sharpening element. The sharpening element is embedded with a diamond abrasive, increasing the friction against the knife being sharpened. Grooves are not present in the sharpening element of the alternative embodiment, but rather, diamond abrasives provide increased friction against the blade being sharpened.

The strength of diamond allows for long and extensive use of the sharpening element. The diamond abrasive 9 may be incorporated in the blade by heating up the blade component of the knife close or at the melting point of the metal from which the blade is constructed and placing the diamond dust within the sharpening element of the blade. Upon cooling, the diamond dust will be embedded within the blade. Sand or silica may be substituted instead of diamond abrasives for a more economic apparatus.

With respect to the above description, it is to be realized that the optimum dimensional relationships for the parts of the invention, to include variations in size, materials, shape, form, function, manner and use are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, while still falling within the scope of the invention.

1. A knife comprising:
A handle portion;
A blade portion;
Said blade portion further comprises a cutting element and a sharpening element.

2. Said knife of claim 1 wherein said sharpening element is comprised of parallel grooves.

3. Said knife of claim 1 wherein said sharpening element is comprised of diamond abrasives.

4. Said knife of claim 1 wherein said sharpening element is comprised of silica abrasives.

5. A knife comprising:
A handle portion;
Said handle portion further comprises a concave ridge; and
A blade portion.

6. Said knife of claim 5 wherein said blade portion includes a cutting element and a sharpening element.

7. Said knife of claim 6 wherein said sharpening element is comprised of parallel grooves.

8. Said knife of claim 6 wherein said sharpening element comprises diamond abrasives.

9. Said knife of claim 6 wherein said sharpening element comprises silica.
